(19) United States
(12) Patent Application Publication
(10) Pub. No.: US 2014/0026424 A1
(43) Pub. Date: Jan. 30, 2014

(54) RAZOR CARTRIDGE

(71) Applicant: The Gillette Company, Boston, MA (US)

(72) Inventors: Oliver David Oglesby, Reading (GB); Keith Edward Paskins, Geneva (CH); Ashok Bakul Patel, Needham, MA (US); Weili Yu, Medfield, MA (US)

(73) Assignee: The Gillette Company, Boston, MA (US)

(21) Appl. No.: 13/936,302

(22) Filed: Jul. 8, 2013

Related U.S. Application Data
(60) Provisional application No. 61/675,068, filed on Jul. 24, 2012.

(51) Int. Cl. B26B 21/40; B26B 21/56

(52) U.S. Cl. CPC B26B 21/4031; B26B 21/565
USPC 30/50

(57) ABSTRACT

A razor having a housing, a guard located at a front of the housing and a cap located at a rear of the housing. A skin contact plane is tangential to the guard and the cap. A blade couplet is disposed in the housing, the blade couplet being formed of a leading blade having a leading edge and a trailing blade having a trailing edge, both edges being directed towards the front of the housing and the leading blade being positioned between the guard and the trailing blade. There is a span of about 25 μm to about 850 μm between the leading edge and the trailing edge, the leading edge has an exposure of about 25 μm to about 500 μm below the skin contact plane, the trailing edge is positioned in line with or above the leading edge and has an exposure of about 150 μm above the skin contact plane to about 300 μm below the skin contact plane, and the difference in exposure between the leading edge and the trailing edge is equal to or less than the span between the leading edge and the trailing edge.

### FIELD OF THE INVENTION

The present invention relates to wet shaving safety razors and more particularly to a safety razor blade unit having multiple blades.

### BACKGROUND OF THE INVENTION

Wet shaving razors have evolved over the years to include a multiplicity of blades with the goal of increasing the closeness of a shave that is achieved while also providing a comfortable shaving experience. One of the main drivers of closeness in shaving is an effect called hysteresis. The hysteresis effect is the meta-stable extension of hair that occurs after a hair is cut during shaving. In present day razors, sharp cutting edges of the cartridge engage with individual hairs during a shaving stroke, exerting a force on the hairs and causing them to be lifted out of the follicle as the razor is moved across the surface of the skin. Once the hair has been cut and the force is removed, the hair retracts back into the skin. There is a time lag before the hair fully retracts and in this time, if a second blade is positioned close enough, it will engage and cut the hair. This concept of consecutive blades cutting hairs before they have fully retracted into the skin is known as “hysteresis cutting”. If the second and consecutive blades also engage and pull hairs while cutting, it becomes possible to get a significantly closer cut than when using a single blade razor.

It is an object of the present invention to exploit the hysteresis effect further to result in a closer shave.

### SUMMARY OF THE INVENTION

According to a first aspect of the invention, there is provided a razor comprising a housing, a guard located at a front of the housing and a cap located at a rear of the housing, a skin contact plane tangential to the guard and the cap, a blade couplet disposed in the housing between the guard and the cap, the blade couplet being formed of a leading blade having a leading edge and a trailing blade having a trailing edge, the leading and trailing edges being directed towards the front of the housing, wherein i) there is a span of between 25 μm and 850 μm between the leading edge and the trailing edge, ii) the leading edge has an exposure of between 25 μm and 500 μm below the skin contact plane, iii) the trailing edge is positioned in line with or above the leading edge and has an exposure of between 150 μm above the skin contact plane to 300 μm below the skin contact plane, and iv) the difference in exposure between the leading edge and the trailing edge is equal to or less than the span between the leading edge and the trailing edge.

### BRIEF DESCRIPTION OF THE DRAWINGS

Embodiments of the invention will hereinafter be described, by way of example, with reference to the accompanying drawings, in which:

FIG. 1 is a perspective view of an embodiment of a razor according to the present invention.

FIG. 2 is a schematic cross-sectional view through an embodiment of a cartridge of the present invention;

FIG. 3 is a schematic view of the cartridge shown in FIG. 2 without additional blades and illustrating different dimensions and measurements used in the present invention;

FIGS. 4a, b, and c illustrates the relationship between the span between adjacent blade edges and the resulting extension of hair, when using an embodiment of the present invention;

FIGS. 5a, b, c, d, e and f shows schematically the interaction between a razor of the present invention and hair when in use;

FIGS. 6a, b and c shows data representing the relationship between different geometries of blades in a cartridge of the present invention;

FIG. 7 shows an alternative embodiment of the blade couplet of the present invention;

FIGS. 8a and b shows embodiments of different blade options of the present invention;

FIGS. 9a, b and c shows alternative embodiments of the layout of blades shown in the razor of FIG. 2;

FIGS. 10a, b and c shows alternative assembly options for the blade couplet of the present invention;

FIG. 11 shows schematically a single fiber cutting rig for measuring the cutting force of blades of the present invention.

### DETAILED DESCRIPTION OF THE INVENTION

The invention is applicable to razor cartridges in general that are used in a wet shaving system.

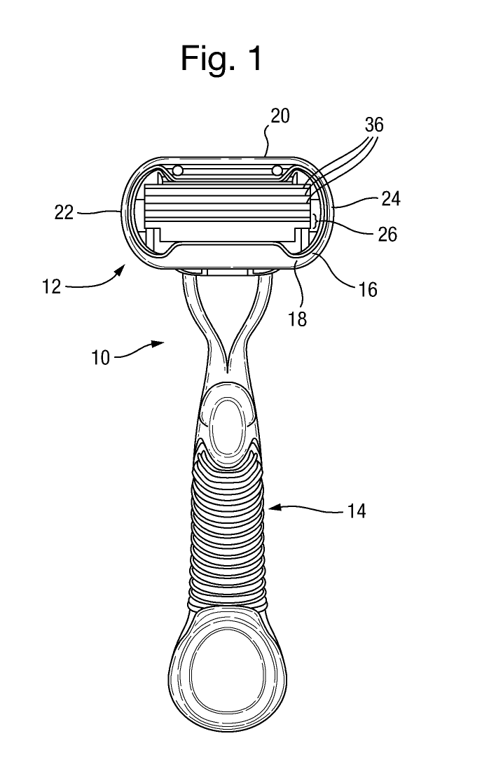

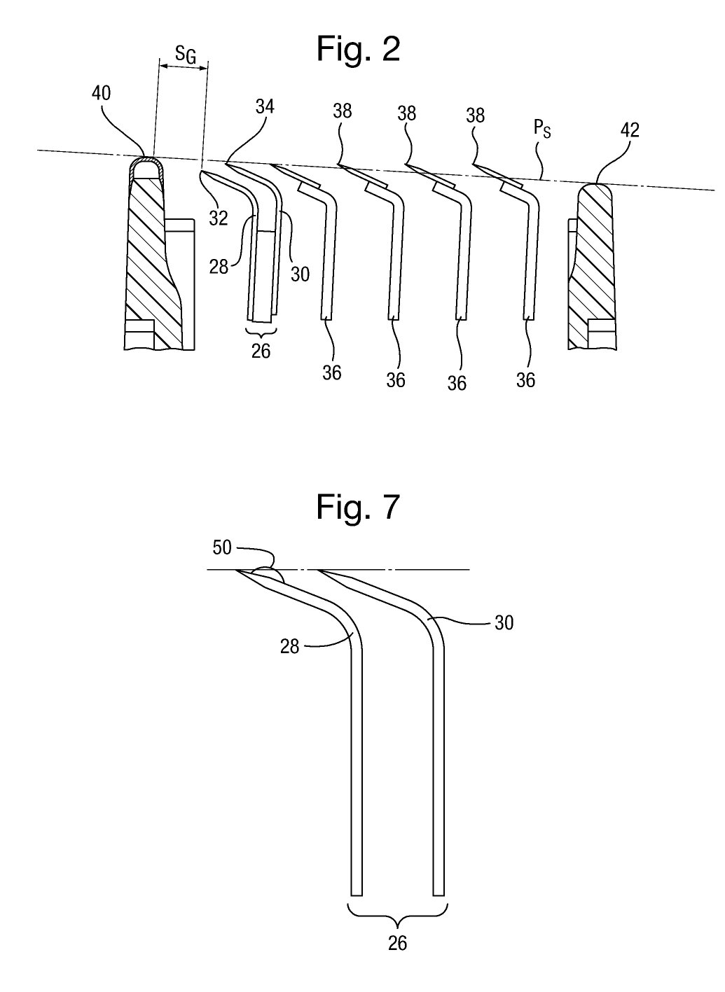

FIG. 1 shows a wet shaving razor 10 formed of a razor cartridge 12 attached to a handle 14. The razor cartridge is formed of a housing 16 having a front wall 18, a rear wall 20 and first and second opposing side walls 22, 24 disposed transverse to and between the front wall and rear wall. A blade couplet 26 (shown more clearly in FIG. 2) formed of a leading blade 28 and a trailing blade 30 is mounted within the housing 16. Each of the leading blade 28 and trailing blade 30 has a cutting edge 32, 34 extending between the first and second opposing side walls 22, 24 and directed towards the front wall. One or more additional blades 36 are disposed in the housing 16, each additional blade having a cutting edge 38 (FIG. 2) extending between the first and second opposing side walls 22, 24 and directed towards the front wall.

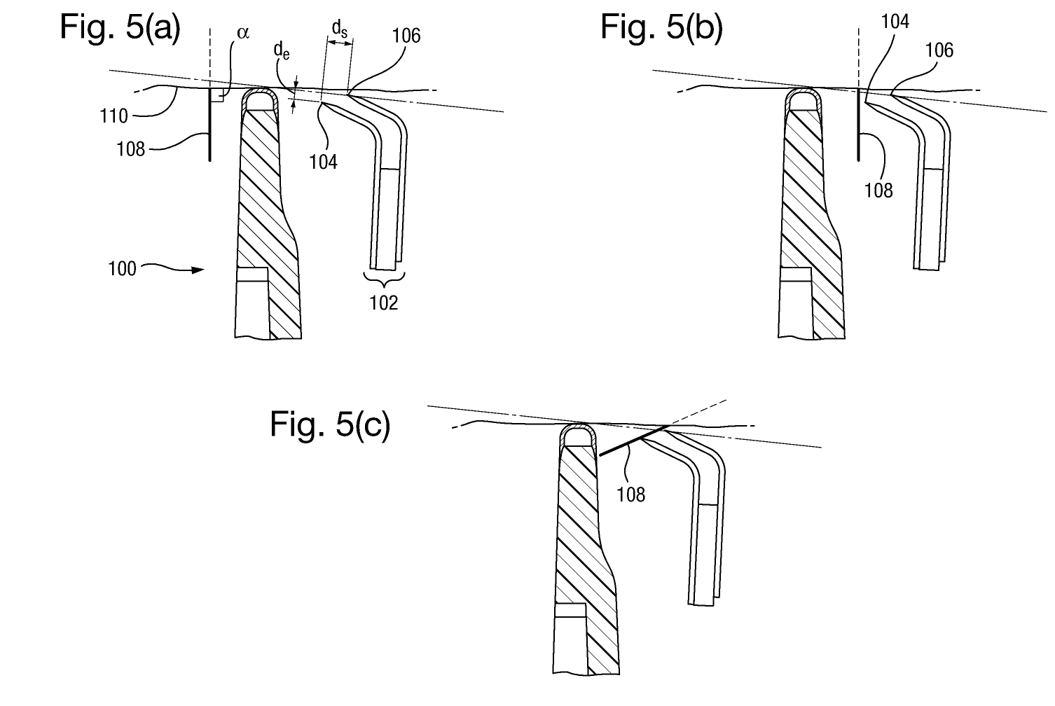

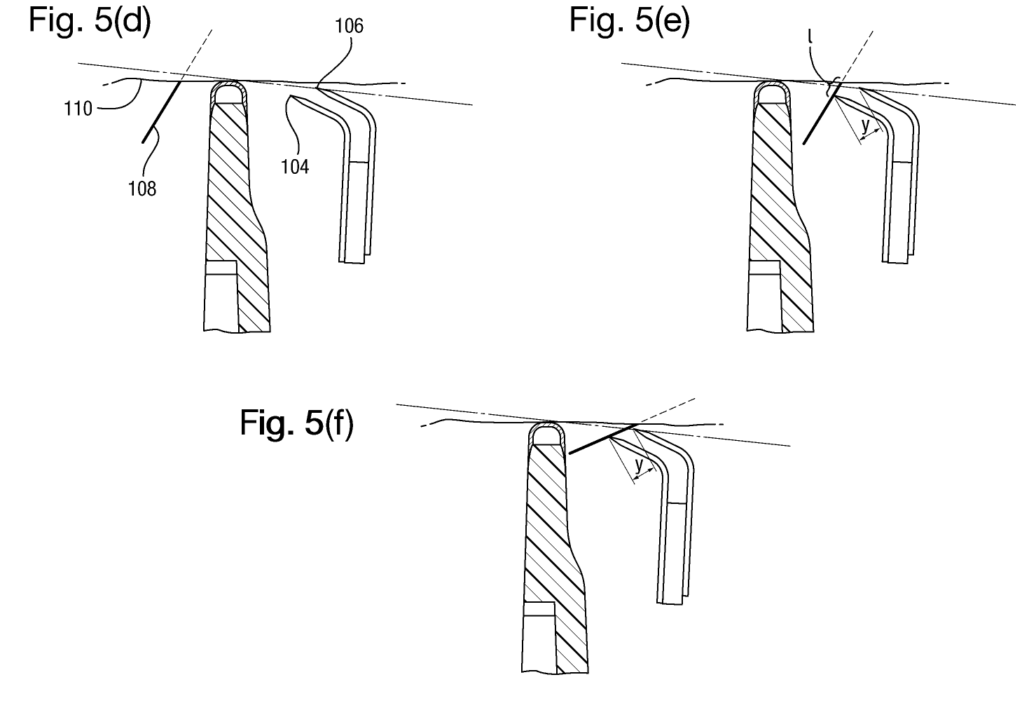

Hysteresis cutting is dependent on the proximity of blade edges to one another in a cartridge; the first blade makes contact with a hair and pulls it from the skin surface and the adjacent blade should be near enough the first blade that it engages with the hair before it has time to fully retract into the skin surface. The present inventors have discovered that to fully capitalize on the extension of a hair while it is being cut by a first blade, it would be desirable for the next/second blade to cut the hair before it has retracted at all. This is most easily achieved if two consecutive blades make contact with the same hair. In an embodiment of the present invention, and as shown schematically in FIG. 5, a blade couplet 26 is provided where the preceding blade of the couplet, in this case the leading blade, is arranged to engage a hair, pulling it as the shaving stroke is progressed, and the trailing blade then cuts the hair—effectively resulting in double engagement of a hair by the blade couplet.

The geometry of the leading and trailing blades relative to one another and relative to a skin contact plane is critical for either a) increasing the probability of achieving double-engagement of a hair, or b) minimizing retraction of a hair before it is cut by the trailing blade.

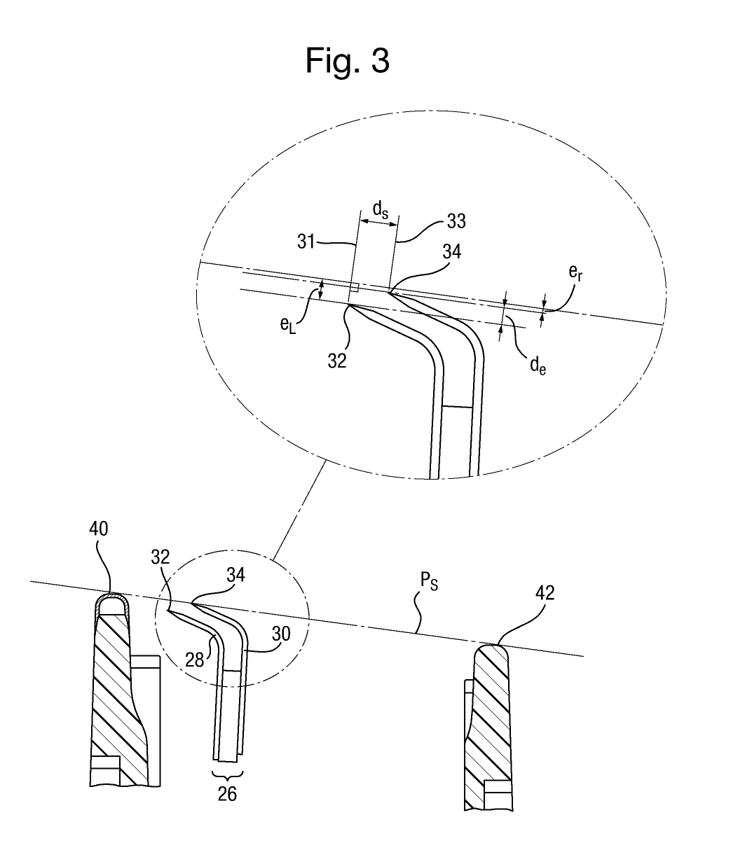

FIG. 3 shows the cartridge of FIG. 2 showing only a first skin contact point 40 at a front of the housing, a second skin contact point 42 provided at a rear of the housing 16 and the blade couplet 26 disposed therebetween. In the embodiment shown in FIGS. 2 and 3, the first skin contact point is a guard and the second skin contact point is a cap. However, it will be appreciated that the first and second skin contact points may take other forms or may be interchanged such that, for example, the guard is provided at the rear of the cartridge and the cap at the front of the cartridge. A skin contact plane Pₛ is defined tangential to the first and second skin contact points, or in the case of the embodiment shown in FIG. 3, the skin contact plane Pₛ is tangential to the guard and cap. As described herein, the main body of the housing 16 of the cartridge is located below the skin contact plane Pₛ. Similarly, the blades are typically located below the skin contact plane, though in some cases, as described below, the tip of the blade may lie in or above the skin contact plane.

FIG. 2 shows the span (δs) between blade edges. The span (δs) is calculated by

a) drawing a first line 31 perpendicular to the skin contact plane Ps and intersecting the tip of the leading edge 32;

b) drawing a second line 33 perpendicular to the skin contact plane Pₛ and intersecting the tip of the trailing edge 34;

c) measuring the shortest distance δs between the first line 31 and the second line 33.

The span (δs) between the leading edge 32 and trailing edge 34 is between about 25 μm, 100 μm, 200 μm or 300 μm and 400 μm, 550 μm, 700 μm, 850 μm. There is greater scope for a hair to be extended as the span between blade edges in the couplet increases. However, if the span between adjacent edges is too great, the hair will be cut, released and/or pulled out by the leading blade 28 before the trailing blade 30 makes contact with the hair.

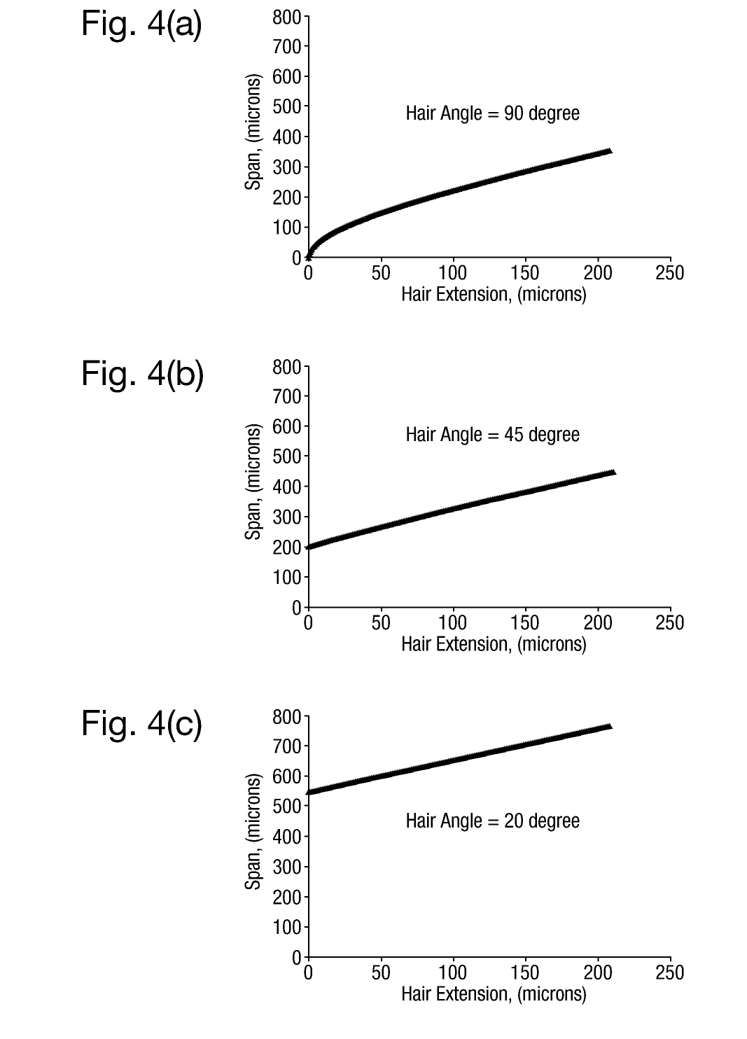

FIG. 4 shows the relationship between span and hair extension as the span is increased when other factors, e.g. exposure of the respective blades, are kept constant. Specifically, FIG. 4 shows the relationship when cutting a hair positioned at a) 90°, b) 45° and c) 20° to the skin. It can be seen from these drawings that in all circumstances, as the span is increased, the expected hair extension also increases. For hairs lying flatter to the skin (e.g. 20°), a greater increase in span is required to result in the same hair extension. The same extension is expected for hair growing at an angle regardless of which direction the hair faces, e.g. the hair could face toward or away from the blades and the expected hair extension will be the same.

Body and/or female hair is typically finer than facial and/or male hair and is normally shaved less frequently. Furthermore, users tend to be more sensitive to pain caused by blades pulling hair when shaving facial hair versus body hair. This level of discomfort is naturally related to the amount that hair is pulled out of the skin. Accordingly, for removal of body hair, the span is preferably between 250 μm and 850 μm. By contrast, for removal of facial hair, the span is preferably between 25 μm and 150 μm.

Exposure of a blade edge (e) is calculated as the distance of a blade edge from the skin contact plane Pₛ in a direction substantially perpendicular to the skin contact plane Pₛ. FIG. 3 shows that exposure can be calculated by:

a) drawing a first line 31 perpendicular to the skin contact plane Ps and intersecting the tip of the leading edge 32, and measuring the distance e_{L} from the tip to the skin contact plane Pₛ along the line 31;

b) drawing a second line 33 perpendicular to the skin contact plane Pₛ and intersecting the tip of the trailing edge 34, and measuring the distance e_{T} from the tip to the skin contact plane Pₛ along the line 33;

The exposure differential δe is the difference between the exposure of the leading blade and the exposure of the trailing blade.

Blade edges can be located above the skin contact plane, otherwise known as having a “positive exposure”, in line with the skin contact plane or below the skin contact plane, known as “negative exposure”. The cutting efficiency of a blade is, in part, determined by its exposure. Cutting edges that are located in or above the skin contact plane tend to cut hair more efficiently than identical edges that are located below the skin contact plane. Since, in the present invention, it is preferred for the leading blade to engage hairs without cutting them, it is preferable for the leading blade edge to be positioned below the skin contact plane.

Added to this, when the leading blade engages with a hair, it will cause the hair to bend towards the skins surface. If the leading blade is positioned too close to the skins surface, the hair will lie flat on the skin as it is extended by the leading blade. This will decrease the likelihood that the trailing blade would then make a clean cut of the hair since it may penetrate the hair at an inefficient angle that may lead to a so-called “skive cut”. A skive-cut occurs when the blade edge cuts into one side of a hair and, rather than cutting straight across the hair, cuts diagonally through the shaft, leaving one side of the hair longer than another side—thus not achieving a clean cut. Accordingly, the leading blade edge has an exposure (e_{L}) of 25 μm or more below the skin contact plane (Pₛ).

Engagement of a hair by the leading edge is additionally dependent on the length of hairs being cut. If the exposure of the leading blade is too great, short hairs will be missed. Accordingly, the leading blade has a maximum exposure e_{L} of 500 μm below the skin contact plane. In embodiments, the leading blade has an exposure of between 50 μm, 75 μm, 100 μm or 150 μm to 200 μm, 250 μm, 300 μm or 400 μm below the skin contact plane.

As the trailing blade of the couplet is required to actually cut hairs that are being pulled by the leading blade, the trailing blade is designed to cut at least as efficiently, preferably more efficiently, than the leading blade. Hairs that are under tension require a lower cutting force to cut than hairs that are not under tension. In the present invention, there is a high likelihood that the leading blade will still be in contact with a hair when the trailing blade penetrates the same hair. As such, the trailing blade may still cut hair efficiently even the trailing blade has the same exposure as that of the leading blade. Accordingly, the trailing blade is positioned either in line with or above the leading blade. To maximize the benefit of the hysteresis effect, it is preferable for hairs to be cut as close to their roots as possible. The trailing edge is accordingly positioned to have an exposure e_{T} of between 150 μm above to 300 μm below the skin contact plane. Placing a blade above the skin contact plane can sometimes increase the likelihood of irritation as the blade edge is more likely to make contact with skin. Accordingly, in a preferred embodiment, the trailing blade is located in the skin contact plane.

To maximize the potential extension of hair before it is cut by the trailing blade, there has to be a balance between the span between the leading and trailing blades and their respective exposures. The amount of expected hair extension is related to the span δs, exposure differential δe between blades and angle α of hair being cut. FIG. 5 shows schematically how the angle of a hair being cut affects the pre-cut extension of a hair. FIGS. 5a) to c) shows the interaction between a razor cartridge 100 incorporating a blade couplet 102 (with leading edge 104 and trailing edge 106 ) and a hair 108 protruding at an angle α relative to the skin surface 110 with a hair positioned substantially normal to the skin surface 110. The leading edge has a negative exposure relative to the skin contact plane. The trailing edge is positioned approximately in the skin contact plane such that the trailing edge is positioned above the leading edge. The exposure differential between the edges is shown as δe. The span between the leading and trailing edge is shown as δs and, in this schematic example, δs is greater than δe.

FIG. 5b) shows the leading edge making contact with the hair 108 as the razor cartridge 100 is moved across the skin surface 110—at which point the trailing edge is NOT in contact with the hair 108. As the razor cartridge 100 is moved further along the skin surface 110 the leading edge grips the hair 108 and extends it from the skin surface 110 until the trailing blade 106 makes contact with and cuts the hair 108. FIGS. 5d) to f) show the same process with a hair positioned at a shallower angle relative to the skin surface. Specifically, FIGS. 5d) to 5f) show a hair positioned at approximately 60° to the skin surface. The extended part E of the hair that is cut is calculated as the distance between the leading edge and the trailing edge (shown as “y” in FIG. 5b) less the distance between the engagement point of the leading blade and a hair (shown as “l” in FIG. 5b).

E=y−l

l is determined by the angle of the hair and difference in exposure between the trailing blade and the leading blade (δe):

l=δe/Sin α

y is distance between adjacent tips of blade edges:

y²=δx²+δe²

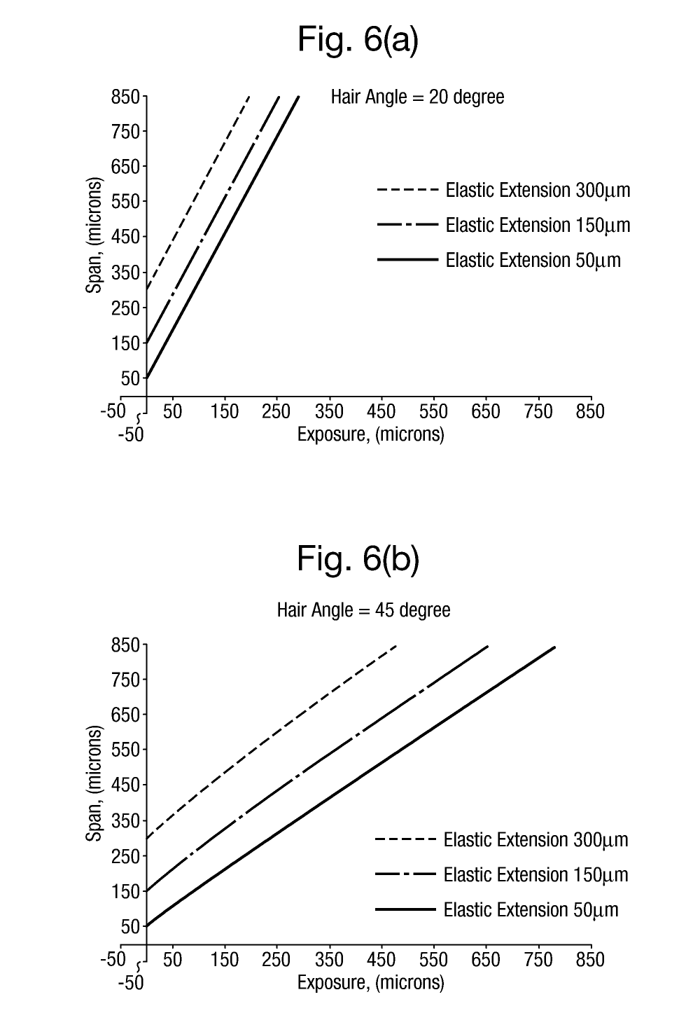

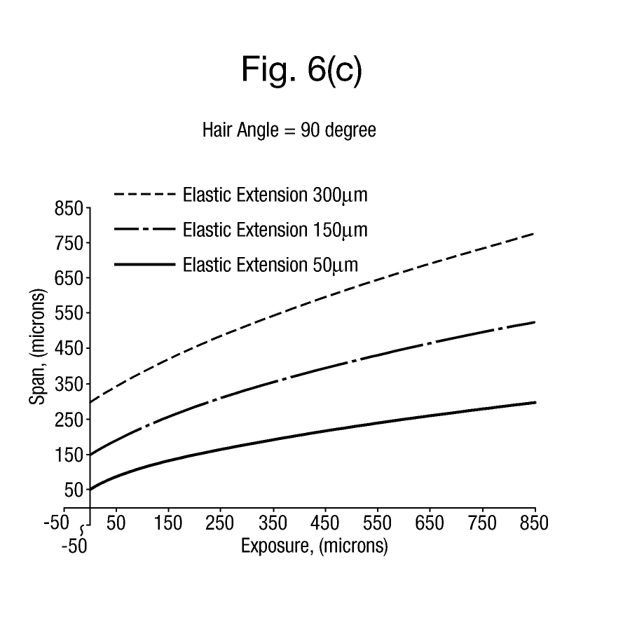

The respective geometries of span δs and exposure differential δe of the blade couplets shown respectively in FIGS. 5a) to 5c) and 5d) to 5f) are the same. It is clear to see that the extension E of hair is greater when the hair is positioned at approximately 90° to the skin surface 110 (FIGS. 5a) to 5c)) versus the extension E when the hair is positioned at approximately 60° to the skin surface (FIGS. 5d) to 5f). This is true since the length l is dependent on the angle of the hair α irrespective of the direction the hair faces (i.e. towards the blade couplet or away from the blade couplet). Since it is not possible to anticipate the angle of hairs that may be cut by a razor cartridge, an assumption is made based on the average angle of hairs (in this case, particularly looking at female leg hairs) where α=45°. FIG. 6 shows the different extensions for hairs positioned at a) 20°, b) 45° and c) 90° with variable spans and exposure differentials. As can be seen, for hairs angled at 20°, it is preferable for the exposure to be significantly less than the span to get any extension. At 45°, there will be some extension provided the exposure is less than the span (regardless of the magnitude by which it differs). At 90°, there would be some extension even if the exposure is greater than the span, however, to achieve any meaningful extension, the leading blade would need to be positioned significantly below the skin contact plane and in such circumstances, would likely not make contact with any hairs. Accordingly, for y to be greater than l and for the leading blade to still make contact with hairs, the span between blades in the couplet must be equal to or greater than the exposure differential.

FIGS. 5a) to 5f) show a differential in relative blade edge exposures that is achieved by physically positioning the trailing blade higher in the cartridge than the leading blade. Alternatively, a leading blade edge having negative exposure relative to the skin contact plane could be achieved by forcing skin away from the blade edge. For example, FIG. 7 shows a blade with a skin deflection strut/bump 50 located on the skin contact side of the blade that, when in use, pushes skin away from the blade edge—resulting in an effective negative exposure. In this embodiment, the leading blade edge may sit in the skin contact plane (i.e. with an exposure of 0), without suffering the effect of the leading blade edge penetrating hairs too close to the skins surface.

As described above, to facilitate double engagement, the leading blade is designed to be somewhat inefficient. In particular, it is preferable for the leading blade to have a cutting force that is sufficient to penetrate a hair, but ideally not cut it all the way through—where the cutting force provides a measure of the effort required by a blade to cut through a hair, or other defined material. By comparison, to minimize any discomfort caused by the trailing blade pulling on hairs that are already extended, the trailing blade is designed to be more efficient at cutting hairs, or other defined material, than the leading blade. As described above in the context of relative exposures of blades, the trailing blade will still cut hairs more efficiently than the leading blade where hairs are held in tension by the leading blade. As such, the trailing blade could cut hairs more efficiently than the leading blade even if the respective cutting forces of the leading and trailing blades when measured in vitro are the same. However, since there is no guarantee that the leading blade will engage with all hairs with which it makes contact until the trailing blade makes contact, in embodiments, the trailing blade has a lower cutting force than the leading blade. Since hair properties vary greatly with respect to their, for example, density, diameter etc., it is appreciated that while this is desirable, it is not possible to design a blade that will achieve this goal with all hairs. For example, in some cases, the leading blade may cut a hair all the way through and, in other cases, the leading blade may not penetrate all hairs with which it makes contact.

Preferably, the cutting force of the leading blade, when measured on a single fiber cutting rig (described below) is between 60 mN, 80 mN, 100 mN or 120 mN and 140 mN, 160 mN, 180 mN or 200 mN.

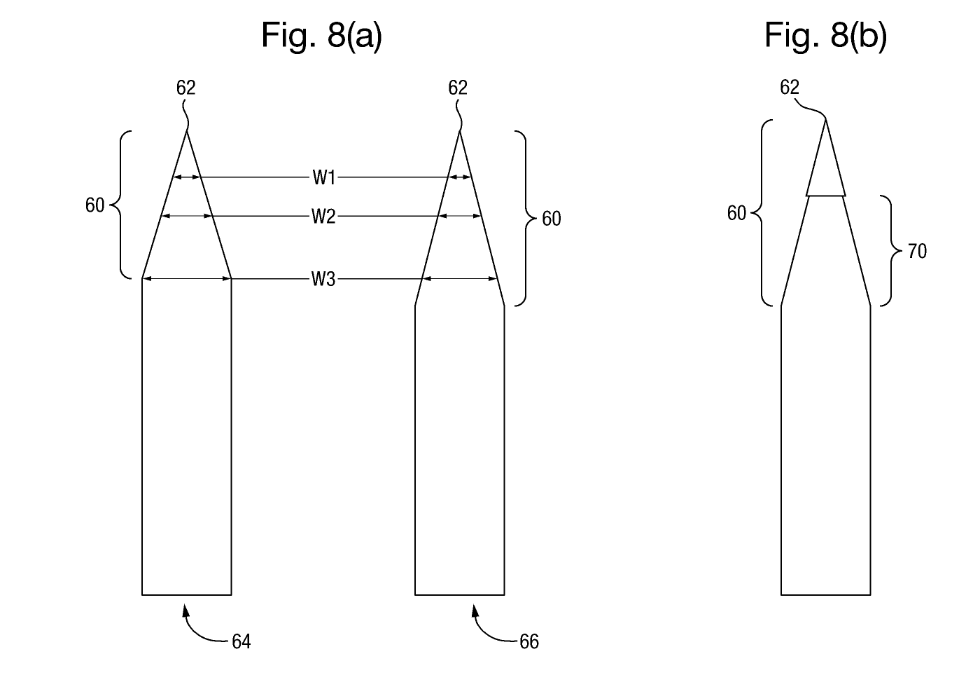

There are many factors that may influence the cutting force of a blade edge 60. For example, coatings with different frictional properties may be applied to a blade or the profile may be varied to make a blade cut more or less efficiently. FIG. 8a) shows two different blade profiles that, if otherwise identical, would have different cutting forces. Comparative measurements are shown below, where w1 w2 and w3 are the widths of the blade measured at 4 μm, 8 μm and 16 μm from the tip 62 respectively:

| | Blade 1 (control blade) | Blade 2 (experimental blade) |
|---|---|---|
| Tip radius | <25 nm | <20 nm |
| w1 | 1 μm to 2 μm | 2.25 μm to 3.25 μm |
| w2 | 2 μm to 3.5 μm | 4 μm to 5 μm |
| w3 | 5 μm to 6 μm | 8 μm to 9 μm |

The table below shows the cutting forces experienced by the Blade 1 64 and Blade 2 66 when measured according to the single fiber cutting method described below.

| | Blade 1 | Blade 2 |
|---|---|---|
| | (Control CF) | (Exp CF) |
| Mean Cutting Force (mN) | 51.789848 | 109.48666 |
| Standard Deviation | 10.026409 | 14.869536 |
| Standard Error Mean | 6101848 | 0.9049311 |
| Upper 95% Mean | 52.991199 | 111.2683 |
| Lower 95% Mean | 50.588497 | 107.70501 |
| N (= sample size) | 270 | 270 |

Blade 2 (the experimental blade) has a tip radius of similar size to the blade 1 (the control blade), but it is otherwise thicker than blade 1 at all measured points. As can be seen above, blade 2 has a higher cutting force than blade 1. Thus, it can be said that blade 2 has an initial penetration force that is roughly equivalent to blade 1, but that the increased thickness in the body of the blade causes blade 2 to have an overall higher cutting force than blade 1—i.e. once the blade has penetrated a hair, it then has to work harder (vs the control blade) to pass through the hair.

There are many ways that this effect may be achieved, and the present application is not limited to the specific example given above. For example, in another embodiment, shown in FIG. 8b), a first coating is applied to the tip 62 of the leading blade and a second coating (or no coating) is applied to the body 70 of the blade. In embodiments, the first coating has a lower coefficient of friction than the second coating and in the specific embodiment shown in FIG. 8b), the first coating is a telomer coating and the remainder of the blade is left free of telomer. In this case, the blade may easily penetrate a hair, but should not easily pass all the way through.

Alternatively, the profile of both blades may be kept the same, but the leading blade may be formed without any telomer top coating. Having a telomer coating reduces the coefficient of friction at the blade to hair interface and accordingly reduces the cutting force. Thus, by removing the telomer outer coating, or by not applying it in the first place, the cutting force is increased.

All of the above described variations to a blade edge can be used in isolation or together with other factors that may be varied to influence the cutting force of a hair.

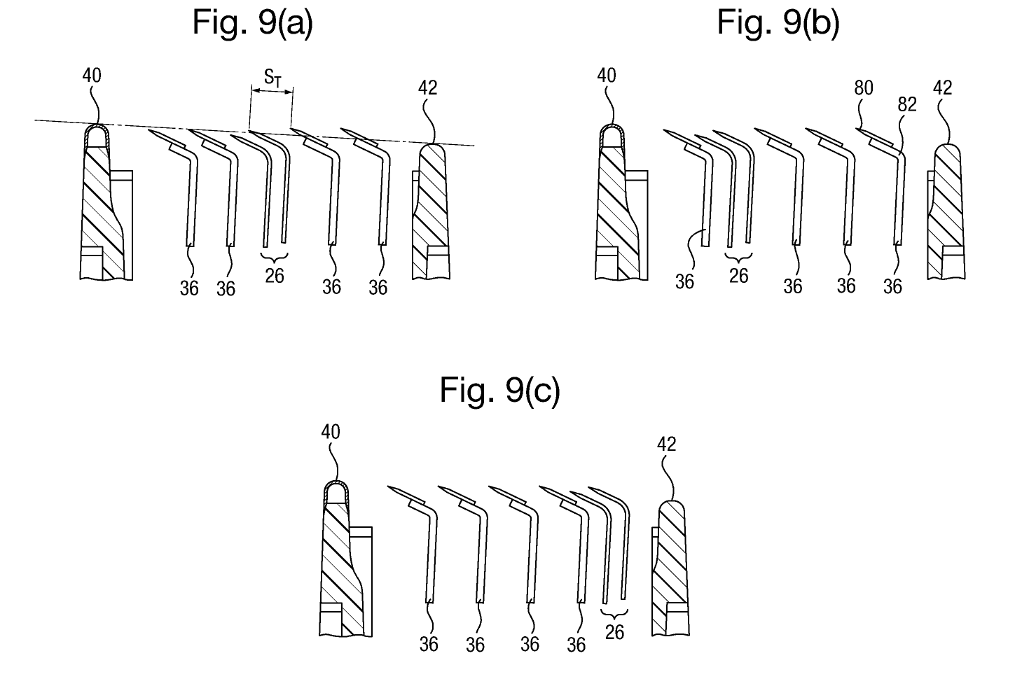

Referring back to FIG. 2, one or more additional blades 36 may be located in the cartridge. In embodiments, the blade couplet 26 is located adjacent the guard 40 and the additional blades 36 are located between the blade couplet 26 and the cap 42. However, it will be appreciated that the additional blades may be located between the guard and the blade couplet or, alternatively, one or more of the additional blades could be located between the guard and the blade couplet and the others between the blade couplet and the cap, as illustrated in any of the embodiments shown in FIGS. 9a) to 9c). If the blade couplet is located adjacent the guard, the percentage of hairs with which the leading blade engages will increase since the hairs are typically longer than if they have been cut by a preceding blade. This is desirable for razors intended for cutting female and/or body hair where reduced levels of pain/discomfort are experienced by a user. For cutting male and/or facial hair, since the area being shaved is more sensitive and the hairs typically thicker, it is preferable for one or more additional blade(s) to be positioned between the guard and the blade couplet so that the hairs are shorter when they come into contact with the blade couplet. Since the hairs are shorter, overall fewer hairs will be engaged by the leading blade resulting in less discomfort as there is a reduced concentration of hairs being pulled from the skin As mentioned above, for cutting male and/or facial hairs, it is preferable to have a smaller span between the leading and trailing blades, specifically between 25 μm and 150 μm.

In embodiments where the blade couplet is positioned adjacent the guard, as shown in FIG. 2, there is preferably a span s_{G} of 500 μm or 750 μm to 1000 μm, 1250 μm or 1500 μm between the guard and the leading blade. Increasing the span between the guard and the leading blade leads to an increase in the likelihood that the leading blade will contact skin, or at the least engage with hairs too close to their roots, as skin will likely bulge into the gap between the two skin contact points. This can, to some degree, be off-set by increasing the frictional properties of the guard, for example, by introducing or increasing the number of plastic fins on the guard provided to stretch skin.

Preferably, there is a span s_{T} of 400 μm, 600 μm or 800 μm to 1000 μm, 1250 μm or 1500 μm between the trailing blade and an adjacent additional blade located between the trailing blade and the cap 42.

All embodiments shown in FIGS. 2 and 9 have four additional blades. It will, however, be appreciated that there may be fewer or more blades located between the blade couplet and the cap and, as mentioned above, one or more additional blades could alternatively or additionally be positioned between the guard and the blade couplet.

In the cartridges shown in FIGS. 2 and 9, the additional blade(s) and the leading and trailing blades are positioned at an angle of between 15° to 45° relative to the skin contact plane Pₛ. It will be appreciated that the angle of blades may be varied from one to another. In the embodiment shown in FIG. 2 in particular, the additional blade(s) 36 are shown to have progressively increasing exposures from the front to the rear of the cartridge. Specifically, the blade adjacent the blade couplet has negative exposure and the blade adjacent the cap has positive exposure. This form of progressive geometry is described in detail in EP 0,722,379. Variation in blade exposure across a cartridge results in a varied load distribution across the blades of a cartridge. The load on respective blades reduces as the exposure is reduced.

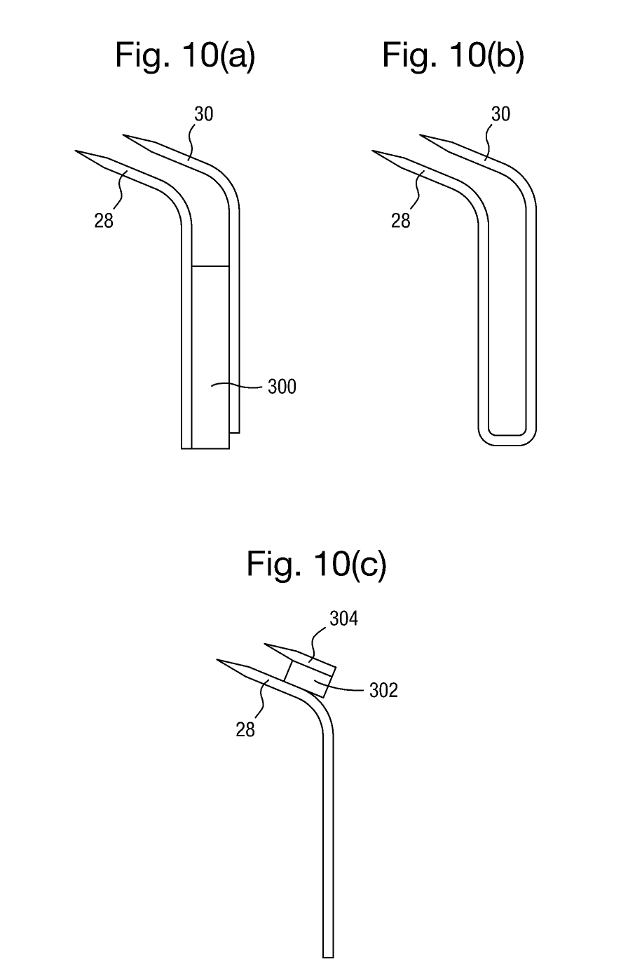

The leading and trailing blades may be secured to one another or directly to the housing. FIG. 10a) shows an embodiment where the leading and trailing blades are secured to either side of a spacer 300. In the embodiment shown, the leading and trailing blades are bent blades, where the blade itself is secured to the spacer. However, it will be appreciated that in an alternative embodiment, the blades may be secured to a blade support 202, and the support 202 may be secured to the spacer. Alternatively, as shown in FIGS. 10b) the blade couplet may be formed from a single sheet of metal with a cutting edge at either end, or, as shown in FIG. 10c), one of the leading and/or trailing blade could have just an edge 304 secured to the other by a spacer 302.

The additional blade(s) 36 may be secured to the housing in any known way, for example, the blades may be attached to blade supports, or they may be bent blades that are secured directly to the housing. In certain embodiments of the present invention, the housing has a blade retaining member having a plurality of slots for receiving either the blade supports or, where bent blades are used, the blades. The angle of the respective blades relative to the skin contact plane can be determined by an angle in the blade support, where blade supports are used, or by a bend in a blade where bent blades are used. Alternatively, the angle of bend in the respective blade supports or bent blades may be kept the same, and the angle of the respective slots in the blade retaining member may be varied to result in blade edges of different angles.

In typical cartridges, the blades are usually carried by the housing, which is generally a molded plastic frame, either independently of each other or in unison under forces imparted on the blades by the skin during shaving. In one embodiment of support within the housing, the blades are mounted fixedly within slots in a blade retaining member. In most instances, there will be one or more rigid blade retaining member disposed along a length of the housing to provide adequate and immovable support for the blades disposed therein. In another instance, the blades may be floatably mounted within the housing, where the blades are supported by one or more spring loaded blade retaining member so they may respond to forces encountered during shaving.

In embodiments, a lubricating strip may be provided on or in place of the cap. If, in use, the skin contact plane is defined by a lubricating strip, rather than the plastic housing, it will be appreciated that the relative exposures of the leading and trailing blade should be determined according to the guard to lubricating-strip tangent.

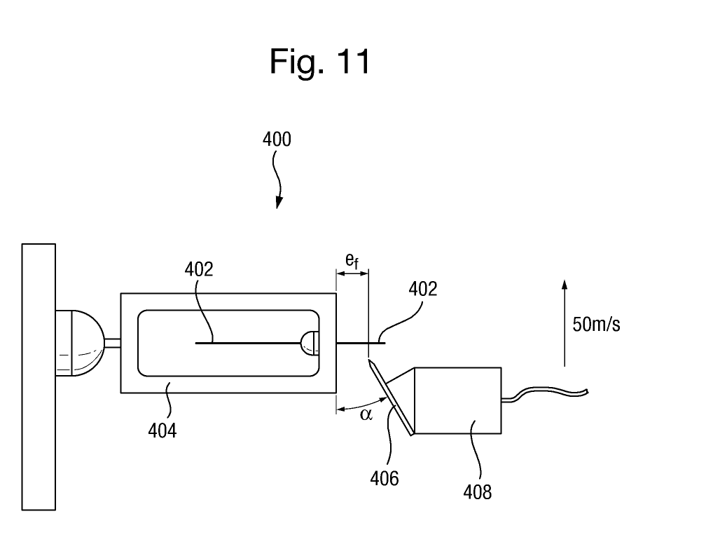

Different methods are provided for quantifying the cutting force of a blade. A “single fiber cutting method”, described in US 2011/0214493, is one method used by The Gillette Company. As shown in FIG. 11, a force cutting rig 400 is provided having a fiber mount 404 for holding a fiber 402 and a blade mount 408 for holding a blade 406. The blade mount is moved linearly towards the fiber until the blade cuts the fiber, as shown schematically in FIG. 11. As the blade cuts the fiber, sensors measure the cutting force exerted by the blade on the fiber. It will be appreciated that the force required to cut a fiber will depend on the fiber used. Furthermore, the angle at which the blade is presented to the fiber will also have an impact on the measured cutting force. Accordingly, for this example, the same fiber is cut twice, once by blade 1 and once by blade 2—both blades being held in the same position when cutting the fiber. For completeness, measurements are only taken when a blade engages with the fiber—if the blade touches the fiber but knocks it down, a negligible force will be measured by the sensor. For the data provided above, the blades are positioned at an angle of 21.5° relative to the surface of the fiber mount (equivalent to having an angle α relative to the skin contact plane of 21.5°) and the fibers are positioned approximately normal (90°) to the surface of the fiber mount. The blade edge is positioned 100 μm from the fiber mount (so with an approximate exposure e_{f} of 100 μm below the skin contact plane) and the blade mount is moved towards and across the fiber at a velocity of 50 mm/s. It will be appreciated that changing these parameters would affect the cutting force measured and result in a different result.

The cutting force measured in the single fiber cutting method is influenced by the properties of the fiber being cut. To facilitate reproducible measurements, the single fiber cutting method uses Asian female scalp hairs that are about 650 mm long with a hair diameter in the range of between 70 μm to 90 μm and with a substantially round diameter, for example, having a ratio of less than 1.5 between the major and minor diameters. Each time the cutting force is measured, approximately 0.5 mm of the hair is cut. Each hair may be cut approximately 1200 times, resulting in 1200 measurements of cutting force. To further ensure reproducibility, each cut with an experimental blade is interleaved with a control blade, and the difference between the two calculated. This is done to mitigate the effects of variation in fiber diameter, mechanical properties, environmental conditions (e.g. temperature and humidity) and instrument variation.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor, comprising:
a) a housing;
b) a guard located at a front of the housing and a cap located at a rear of the housing;
c) a skin contact plane tangential to the guard and the cap;
d) a blade couplet disposed in the housing between the guard and the cap, the blade couplet being formed of a leading blade having a leading edge and a trailing blade having a trailing edge, wherein the leading and trailing edges are directed towards the front of the housing and the leading blade is positioned between the trailing blade and the guard, wherein:
i) there is a span of about 25 μm to about 850 μm between the leading edge and the trailing edge;
ii) the leading edge has an exposure of about 25 μm to about 500 μm below the skin contact plane;
iii) the trailing edge is positioned in line with or above the leading edge and has an exposure of about 150 μm above the skin contact plane to about 300 μm below the skin contact plane,
iv) the difference in exposure between the leading edge and the trailing edge is equal to or less than the span between the leading edge and the trailing edge.

2. A razor as claimed in claim 1, wherein the blade couplet has a span of between about 250 μm and about 600 μm between the leading edge and the trailing edge.

3. A razor as claimed in claim 1, wherein the leading edge has an exposure of about 100 μm to about 200 μm below the skin contact plane.

4. A razor as claimed in claim 1, wherein the trailing edge lies in the skin contact plane.

5. A razor as claimed in claim 1, having a span of about 500 μm to about 1500 μm between the guard and the leading edge.

6. A razor as claimed in claim 1, wherein the trailing blade has a cutting force that is equal to or less than the cutting force of the leading blade.

7. A razor as claimed in claim 6, wherein the cutting force of the leading blade is about 40 mN to about 200 mN.

8. A razor as claimed in claim 1, the leading blade comprising a tip and a body, wherein a first coating is applied to the tip and a second coating is applied to the body and the first coating has a lower coefficient of friction than the second coating.

9. A razor as claimed in claim 1, the leading blade comprising a tip and a body, the tip having a radius of up to about 30 nm and the body having a thickness of about 4 μm to about 5 μm at about 8 μm from the tip.

10. A razor as claimed in claim 1, further comprising one or more additional blades, each of the one or more additional blade(s) having a cutting edge directed towards a front of the housing, the additional blade(s) being disposed in the housing between the guard and the blade couplet.

11. A razor as claimed in claim 1, further comprising one or more additional blades, each of the one or more additional blade(s) having a cutting edge directed towards a front of the housing, the additional blade(s) being disposed in the housing between the blade couplet and the cap.

12. A razor as claimed in claim 11 having a span of about 400 μm to about 1500 μm between the trailing edge and at least one of the one or more additional blade(s).

13. A razor as claimed in claim 1, further comprising one or more additional blades, each of the one or more additional blade(s) having a cutting edge directed towards a front of the housing, wherein one or said one or more additional blade(s) is located between the guard and the blade couplet and the others of the one or more additional blade(s) are located between the blade couplet and the cap.

14. A razor as claimed in claim 1, wherein the leading blade and trailing blade are attached to opposite sides of a spacer.

15. A razor as claimed in claim 1, wherein at least one of the leading blade and trailing blade is a bent blade.
